(19) United States
(12) Patent Application Publication
(10) Pub. No.: US 2026/0353505 A1
(43) Pub. Date: Nov. 5, 2026

(54) METHOD, DEVICE AND COMPUTER STORAGE MEDIUM OF COMMUNICATION

(71) Applicant: NEC CORPORATION, Tokyo (JP)

(72) Inventors: Gang WANG, Beijing (CN); Lei CHEN, Beijing (CN)

(73) Assignee: NEC CORPORATION, Tokyo (JP)

(21) Appl. No.: 19/107,989

(22) PCT Filed: Sep. 9, 2022
(86) PCT No.: PCT/CN2022/118263

§ 371 Date: Feb. 28, 2025

(51) Int. Cl. H04W 76/28; H04W 72/23

(52) U.S. Cl. CPC H04W 76/28; H04W 72/23

(57) ABSTRACT

Embodiments of the present disclosure relate to methods, devices and computer readable media for communication. A terminal device receives a configuration of DRX cycle from a network device and determines a starting time for a DRX cycle at least based on the configuration of DRX and information of a hyper frame associated with the DRX cycle. Then the terminal device performs a downlink channel monitoring based on the starting time. In this way, a starting time of a DRX cycle may be roughly aligned with arrival time of a packet without accumulated latency, wasted resource, additional signaling overhead and SFN wraparound mismatch issue.

### TECHNICAL FIELD

Embodiments of the present disclosure generally relate to the field of telecommunication, and in particular, to methods, devices and computer storage media of communication for discontinuous reception (DRX) configuration.

### BACKGROUND

Currently, power saving becomes an important topic for services with periodic packets in terms of control signaling overhead and scheduling latency, especially for an extended reality (XR) service such as virtual reality (VR), augmented reality (AR), cloud gaming, etc. For both downlink and uplink, a video stream is identified as a key traffic type. Typically, a video stream has 60 or 90 or 120 frames per second (FPS), which means that packets will arrive at radio access network (RAN) every 1/60, 1/90 or 1/120 second. However, a periodicity of a DRX cycle in current specification is an integer number of milliseconds. It is impossible to configure a starting time of a DRX cycle that matches the arrival time of the packets perfectly. Such mismatch between the arrival time of the packets and the starting time of the DRX cycle becomes an issue.

### SUMMARY

In general, embodiments of the present disclosure provide methods, devices and computer storage media of communication for DRX configuration.

In a first aspect, there is provided a method of communication. The method comprises: receiving, at a terminal device and from a network device, a configuration of DRX cycle; determining a starting time for a DRX cycle at least based on the configuration of DRX cycle and information of a hyper frame associated with the DRX cycle; and performing a downlink channel monitoring based on the starting time.

In a second aspect, there is provided a method of communication. The method comprises: transmitting, at a network device and from a terminal device, a configuration of DRX cycle; determining a starting time for a DRX cycle at least based on the configuration of DRX cycle and information of a hyper frame associated with the DRX cycle; and performing a downlink transmission based on the starting time.

In a third aspect, there is provided a device of communication. The device comprises a processor configured to perform the method according to the first aspect of the present disclosure.

In a fourth aspect, there is provided a device of communication. The device comprises a processor configured to perform the method according to the second aspect of the present disclosure.

In a fifth aspect, there is provided a computer readable medium having instructions stored thereon. The instructions, when executed on at least one processor, cause the at least one processor to perform the method according to the first aspect of the present disclosure.

In a sixth aspect, there is provided a computer readable medium having instructions stored thereon. The instructions, when executed on at least one processor, cause the at least one processor to perform the method according to the second aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which some embodiments of the present disclosure can be implemented;

FIG. 1B illustrates a schematic diagram illustrating an example operation in a DRX cycle;

FIG. 2 illustrates a schematic diagram illustrating an example scenario of mismatch between XR frame packets and DRX cycles according to conventional solution;

FIG. 3 illustrates a schematic diagram illustrating a process for communication for DRX configuration according to embodiments of the present disclosure;

FIG. 4A illustrates a schematic diagram illustrating an example configuration with a positive non-integer DRX cycle length according to embodiments of the present disclosure;

FIG. 4B illustrates a schematic diagram illustrating an example scenario in the example configuration of FIG. 4A;

FIG. 5A illustrates a schematic diagram illustrating an example configuration of DRX cycle according to embodiments of the present disclosure;

FIG. 5B illustrates a schematic diagram illustrating another example configuration of DRX cycle according to embodiments of the present disclosure;

FIG. 5C illustrates a schematic diagram illustrating still another example configuration of DRX cycle according to embodiments of the present disclosure;

FIG. 6 illustrates an example method of communication implemented at a terminal device in accordance with some embodiments of the present disclosure;

FIG. 7 illustrates an example method of communication implemented at a network device in accordance with some embodiments of the present disclosure; and

FIG. 8 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (LAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best.’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present application, the term “symbol” refers to an orthogonal frequency division multiplexing (OFDM) symbol or a discrete Fourier transform spread OFDM (DFT-s-OFDM) symbol. The term “slot” includes multiple consecutive symbols, e.g., 14 symbols, or 12 symbols. The term “mini-slot” includes one or more consecutive symbols, and has less symbol than a slot, e.g., 1, 2, 4, or 7 symbols.

As mentioned above, it is impossible to configure a starting time of a DRX cycle that matches arrival time of packets for some services such as XR service perfectly. To enhance performance of related services, such mismatch between the arrival time of packets and the periodicity of DRX cycle needs to be handled.

Embodiments of the present disclosure provide a solution for solving the above and other potential issues. In the solution, a configuration of DRX cycle is designed so that a DRX cycle is associated with a hyper frame. In this way, a periodicity of DRX cycle may be roughly aligned with arrival time of a packet without accumulated latency, wasted resource and additional signaling overhead. Further, there is no need to reconfigure or reactivate DRX configuration when system frame number (SFN) wraps around, and thus signaling overhead may be reduced. In addition, embodiments of the present disclosure may support all currently known frame rates of applications as well as any potential frame rates in the future.

Embodiments of the present disclosure may be applied to any suitable scenarios. For example, embodiments of the present disclosure may be implemented for XR. Alternatively, embodiments of the present disclosure can be implemented in one of the followings: reduced capability NR devices, NR multiple-input and multiple-output (MIMO), NR sidelink enhancements, NR systems with frequency above 52.6 GHz, an extending NR operation up to 71 GHz, narrow band-Internet of Thing (NB-IoT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

Principles and implementations of the present disclosure will be described in detail below with reference to the figures.

### Example of Communication Network

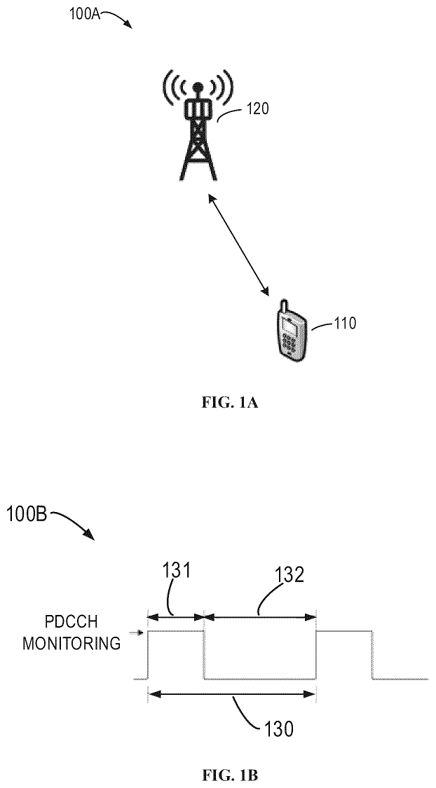

FIG. 1A illustrates a schematic diagram of an example communication network 100A in which some embodiments of the present disclosure can be implemented. As shown in FIG. 1A, the communication network 100A may include a terminal device 110 and a network device 120. In some embodiments, the terminal device 110 may be served by the network device 120. It is to be understood that the numbers of terminal devices and network devices in FIG. 1 are given for the purpose of illustration without suggesting any limitations to the present disclosure. The communication network 100A may include any suitable number of network devices and/or terminal devices adapted for implementing implementations of the present disclosure.

As shown in FIG. 1A, the terminal device 110 may communicate with the network device 120 via a channel such as a wireless communication channel. The communications in the communication network 100A may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In some embodiments, the network device 120 may transmit a configuration of DRX cycle to the terminal device 110. In this case, the terminal device 110 may perform a downlink channel monitoring based on the configuration of DRX cycle. FIG. 1B illustrates a schematic diagram 100B illustrating an example operation in a DRX cycle. As shown in FIG. 1B, a DRX cycle 130 comprises an active phase 131 (i.e., on duration) and an inactive phase 132 (i.e., an opportunity for DRX). The terminal device 110 performs a downlink channel monitoring such as a PDCCH monitoring only in the active phase 131.

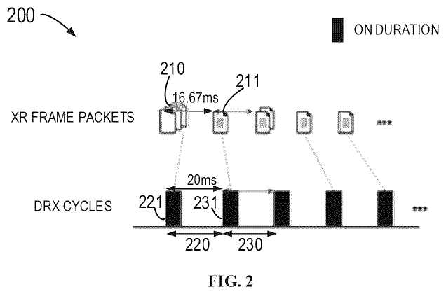

In some scenarios, a network device may transmit XR frame packets to a terminal device and the terminal device may receive the XR frame packets from the network device. FIG. 2 illustrates a schematic diagram illustrating an example scenario 200 of mismatch between XR frame packets and DRX cycles according to conventional solution. In this example, the XR frame packets comprise XR video stream with 60 FPS. That is, the XR frame packets will roughly arrive at RAN every 1/60 second (i.e., about 16.67 ms). Assuming that a periodicity of DRX cycles is configured as 20 ms. In the context of the present application, a starting time of a DRX cycle refers to a starting time of an active phase (on duration) of the DRX cycle.

As shown in FIG. 2, assuming that an arrival time of XR frame packets 210 aligns with a starting time 221 of a DRX cycle 220 perfectly. As a time interval between the XR frame packets 210 and next XR frame packets 211 is 16.67 ms and a time interval between the starting time 221 of the DRX cycle 220 and a starting time 231 of next DRX cycle 230 is 20 ms, the arrival time of the XR frame packets 211 will mismatch the starting time 231 of the DRX cycle 230. In this example, the starting time 231 of the DRX cycle 230 is later than the arrival time of the XR frame packets 211.

Generally, if a starting time of a DRX cycle is earlier than an arrival time of packets, i.e., an on duration starts before the packet arriving, a terminal device may need to keep awake for a long time to search a downlink control channel such as a PDCCH. Thus, too much power will be wasted. If a starting time of a DRX cycle is later than an arrival time of packets, i.e., an on duration starts after the packet arriving, overall transmission delay of packets will be increased. In addition, some of on durations may be wasted since no packet arrives within or before these on durations.

According to current specification, a DRX cycle is only allowed to be configured as integer number of milliseconds. Thus, the mismatch as described in FIG. 2 still presents. Dynamic adaptation of DRX has been identified to be a potential area for XR, and needs to be further developed.

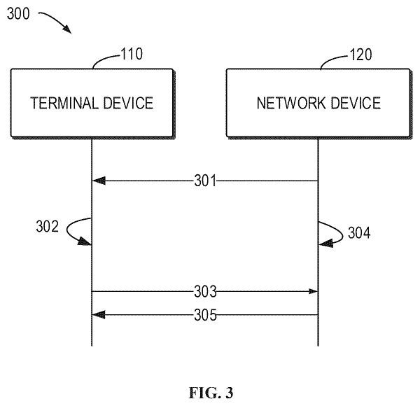

In view of the above, embodiments of the present disclosure provide a solution for DRX configuration to overcome the above and other potential issues. The configuration of DRX cycle is designed so that a DRX cycle is associated with a hyper frame. This will be described in detail with reference to FIGS. 3 to 5C.

In the context of the present application, the term “DRX cycle” may refer to a long DRX cycle or a short DRX cycle or both.

### Example Implementation of DRX Configuration

FIG. 3 illustrates a schematic diagram illustrating a process 300 for communication for DRX configuration according to embodiments of the present disclosure. For the purpose of discussion, the process 300 will be described with reference to FIG. 1A. The process 300 may involve the terminal device 110 and the network device 120 as illustrated in FIG. 1A.

As shown in FIG. 3, the network device 120 transmits 301, to the terminal device 110, a configuration of DRX cycle. In some embodiments, the configuration may be configured for a long DRX cycle. In some embodiments, the configuration may be configured for a short DRX cycle. In some embodiments, the configuration may be configured for both a long DRX cycle and a short DRX cycle.

In some embodiments, the configuration may indicate at least one of the following: a length of DRX cycle, a start offset for DRX cycle, or a slot offset for DRX cycle. In some embodiments, the length of DRX cycle may be a non-integer value (also referred to as a nominal DRX cycle length herein). The non-integer value may refer to non-integer number of time units. In some embodiments, the length of DRX cycle may be an integer value. The integer value may refer to integer number of time units. In the context of the present application, the time unit may be millisecond or subframe or slot or mini-slot or OFDM symbol.

In some embodiments, the terminal device 110 may determine a starting time for a DRX cycle based on the configuration. In the context of the present application, a starting time of a DRX cycle is the time to start an on-duration timer, wherein the on-duration is the duration at the beginning of a DRX cycle, and the on-duration timer is determined based on RRC information drx-onDuration Timer.

In some embodiments, the terminal device 110 may determine the quotient of an index of time unit and the nominal DRX cycle length, and determine an integer by rounding down the quotient. Then, the terminal device 110 may determine a starting time of DRX cycle based on the determined integer.

For example, a starting time may be determined based on equations (1) and (2) below.

floor[Ns−floor(Ns/p)*p]=drx_StartOffset (1)

where floor( ) denotes a function of rounding down operation, p denotes the length of DRX cycle, drx_StartOffset denotes the start offset for DRX cycle, and Ns is determined by equation (2):

Ns=SFN*10+Nsub (2)

where SFN denotes a system frame number, and Nsub denotes a subframe number.

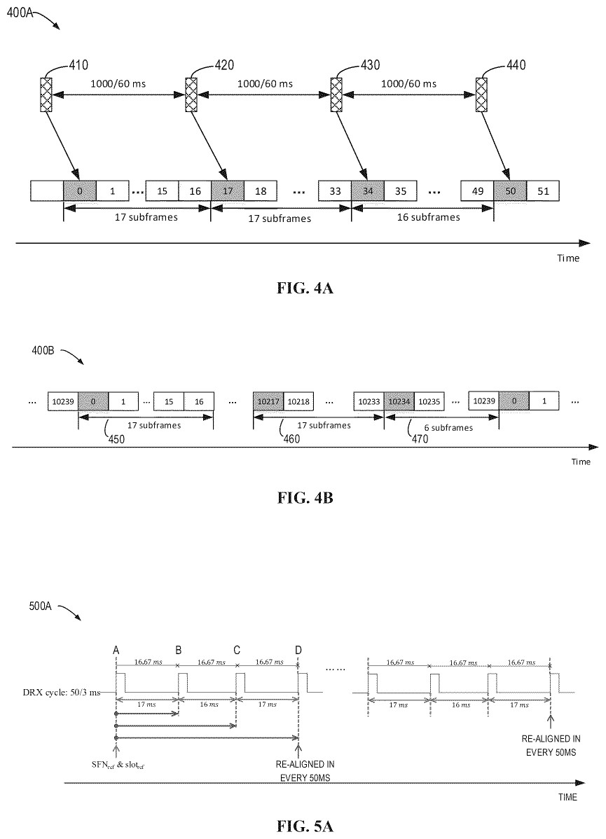

For a subframe with an index Ns, if the equation (1) is true, the DRX cycle should be started after drx_SlotOffset (drx_SlotOffset denotes the slot offset for DRX cycle) from the beginning of the subframe. In this way, a starting time may be determined. For clarity, an example will be described with reference to FIG. 4A.

FIG. 4A illustrates a schematic diagram 400A illustrating an example configuration with a positive non-integer DRX cycle length according to embodiments of the present disclosure. In this example, p=1000/60 ms, drx_StartOffset=0, and drx_SlotOffset=0.

As shown in FIG. 4A, assuming that data transmission 410 is the first data transmission within a period and has SFN=0. Based on the equations (1) and (2), a DRX cycle for the data transmission 410 may be determined to be started at subframe 0. After 1000/60 ms, data transmission 420 may arrive. Based on the equations (1) and (2), a DRX cycle for the data transmission 420 may be determined to be started at subframe 17. Similarly, based on the equations (1) and (2), a DRX cycle for the data transmission 430 may be determined to be started at subframe 34 and a DRX cycle for the data transmission 430 may be determined to be started at subframe 50.

It should be noted that although the starting time of DRX cycle is described in a subframe level in the example of FIG. 4A, the starting time of DRX cycle may also be in any other suitable timing units. For example, the starting time of DRX cycle may be in a symbol or mini-slot level. The present disclosure does not limit this aspect.

It can be seen that the gaps between starting times of DRX cycle for adjacent data transmissions among the data transmissions 410, 420, 430, 440 are 17 subframes, 17 subframes and 16 subframes. The gaps are non-uniform. In this way, a DRX cycle may be roughly aligned with the periodicity of arrival time of a XR packet, and thus additional power consumption due to the misalignment may be avoided. In addition, there is no accumulated offset between DRX cycle and the packet arrival time, and thus it is avoided that the packet arrives at the time outside the on duration of the DRX cycle.

In some embodiments, for short DRX cycle, the equation (1) may be modified as equation (3) below.

floor[Ns−floor(Ns/p)*p]=floor[drx_StartOffset−floor(drx_StartOffset/p)*p] (3)

where floor( ) denotes a function of rounding down operation, p denotes the length of DRX cycle, drx_StartOffset denotes the start offset for DRX cycle, and Ns is determined by the above equation (2).

It is to be understood that each of the equations (1) and (2) may be equivalent to equation (4) below.

floor(Ns modulo p)=drx_StartOffset and floor(Ns modulo p)=floor(drx_StartOffset modulo p) (4)

where floor( ) denotes a function of rounding down operation, p denotes the length of DRX cycle, drx_StartOffset denotes the start offset for DRX cycle, Ns is determined by the above equation (2), and modulo denotes a modulo operation for rational numbers if p is a non-integer number, and modulo denotes a modulo operation for integer numbers if p is an integer number. For example, for two rational or integer numbers a and b, a modulo b=a−floor(a/b)*b.

However, upon determination of a set of starting times for a set of DRX cycles based on the above embodiments as exemplified by the equations (1)-(4), an issue may occur at a boundary of a SEN period. A SFN period includes multiple consecutive SFNs, e.g., from SFN 0 to SFN 9, or from SFN 100 to SFN 199. In the context of the present application, the term “SFN period” may refer to a time duration from SFN 0 to SFN 1023. The SEN period equals to 10.24 seconds (10240 ms) or 10240 subframes. After SFN 1023, the SEN period repeats from SFN 0 to SFN 1023. In some embodiments, the term “SFN period” and “hyper frame” may be used interchangeably.

Obviously, the duration of a SFN period (i.e., 10240 ms) is not an integer multiple of the nominal DRX cycle length, even for some integer DRX cycle lengths, e.g., 3 ms, 7 ms, or 17 ms. Thus, there may be not enough subframes left for the last DRX cycle in a SFN period. For clarity, an example is described in connection with FIG. 4B.

FIG. 4B illustrates a schematic diagram illustrating an example scenario 400B in the example configuration of FIG. 4A. Assuming that a set of starting times are determined based on the equations (1) and (2). As shown in FIG. 4B, a DRX cycle 450 may be determined to be started at subframe 0 and last 17 subframes, and a DRX cycle 460 may be determined to be started at subframe 10217 and last 17 subframes. In similar way, the last DRX cycle may be determined to be started at subframe 10234 and last 16 subframes. However, in fact, there are only 6 subframes left for this SEN period, as shown in FIG. 4B. That is, a DRX cycle 470 is started at subframe 10234 but only 6 subframes are actually available. Furthermore, the next DRX cycle will start at SFN 0 of next SFN period. Thus, there will be no enough subframes for the last DRX cycle in a SEN period. This may be called as a SFN wraparound mismatch issue here.

To solve the above mismatch issues as described in FIGS. 2 and 4A to 4B, embodiments of the present disclosure provide a solution for determining a starting time of a DRX cycle. Continue to refer to FIG. 3, in the solution, upon reception of the configuration, the terminal device 110 determines 302 a starting time for a DRX cycle at least based on the configuration of DRX cycle and information of a hyper frame associated with the DRX cycle.

For illustration, some example embodiments will be described in connection with Embodiments 1 to 5.

### Embodiment 1

In this embodiment, the definition of Ns in the above equation (1) or (4) is modified so as to avoid the situation where there will be no enough subframes for the last DRX cycle in a SFN period.

In some embodiments, the terminal device 110 may consider at least one of the following conditions of a SFN period for determination of a starting time: whether the SFN period is ended; whether the SEN period is started; whether the SFN is 1023; whether the SFN is 0; whether the SFN changes from 1023 to 0; or the index of the SFN period. Of course, any other suitable conditions of the SFN period are also feasible.

In some embodiments, the terminal device 110 may determine Ns based on an index of a SFN period, a SFN and a subframe number associated with a DRX cycle. For example, Ns may be modified as being determined by equation (5) below.

Ns=(Np*1024+SFN)*10+Nsub (5)

where SFN denotes a system frame number, Nsub denotes a subframe number, and Np denotes a value of a counter for SFN periods (may also referred to as an index of a SFN period herein).

In some embodiments, Np starts from 0 after the DRX is configured and Np increases by 1 when a SFN period ends or a SFN period starts (in other words, at the end of SFN 1023 or at the beginning of SFN 0). In some embodiments, in response to receiving a medium access control (MAC) control element (CE) or downlink control information (DCI) from the network device 120 to activate or modify a DRX configuration, the terminal device 110 may set or reset Np to be 0.

In some embodiments, the terminal device may determine the value of Np based on the receiving time of the configuration of DRX cycle. For example, assuming the configuration of DRX cycle is received in a slot, and the slot belongs to a hyper frame, the terminal device may determine Np equals zero for the hyper frame, and Np increases by 1 when a new hyper frame starts. For another example, assuming the configuration of DRX cycle is received in a slot or subframe or system frame, and the slot or subframe or system frame belongs to a hyper frame, if the time duration between the start of the hyper frame and the start or end of the slot or subframe or system frame is smaller or not greater than a threshold, the terminal device may determine Np equals one for the hyper frame; otherwise, if the time duration between the start of the hyper frame and the start or end of the slot or subframe or system frame is greater or not smaller than a threshold, the terminal device may determine Np equals zero for the hyper frame, and Np increases by 1 when a new hyper frame starts. As an example, the threshold is the number of OFDM symbols, or number of slots, or number of subframes, or number of system frames.

In some embodiments, the configuration of DRX cycle may comprise a reference Hyper System Frame Number (H-SFN). The terminal device 110 may determine the value of Np based on the reference H-SFN. For example, the terminal device 110 may determine that Np is zero in a closest hyper frame with an H-SFN number same as the reference H-SFN, and Np increases by 1 when a new hyper frame starts. In some embodiments, the H-SFN of the hyper frame may be determined based on system information block one (SIBI) information. In some embodiments, the H-SFN of the hyper frame may be determined based on a RRC information element.

In some embodiments, the terminal device 110 may determine the value of Np based on an indication of a half hyper frame. In some embodiments, if the configuration of DRX cycle comprises an indication of a half hyper frame, and the terminal device 110 receives the configuration of DRX cycle in a second half of a hyper frame, for example, the terminal device 110 receives the configuration of DRX cycle in a system frame with a SFN between 512 to 1023, the terminal device 110 may determine that Np is zero for the current hyper frame and increases by one when a next hyper frame starts. In some embodiments, if the configuration of DRX cycle comprises an indication of a half hyper frame, and the terminal device 110 receives the configuration of DRX cycle in a first half of a hyper frame, for example, the terminal device 110 receives the configuration of DRX cycle in a system frame with a SFN between 0 to 511, the terminal device 110 may determine that Np is one in the current hyper frame and increases by one when a next hyper frame starts. In some embodiment, if the configuration of DRX cycle does not comprise an indication of a half hyper frame (e.g., an indication of a half hyper frame is not configured, or the configuration of DRX cycle comprises an indication of a first half of a hyper frame), the terminal device 110 may determine that Np is zero in the current hyper frame and increases by one when a next hyper frame starts. In fact, the indication of the half hyper frame refers to an indication of a second half of a hyper frame. For example, the indication of the second half of the hyper frame may comprise any SFN in a range from 512 to 1023. It is to be understood that any other suitable ways are also feasible.

Since there is a delay between time of generation of the configuration of DRX cycle and time of transmission of the configuration of DRX cycle, it is possible that a network device may generate the configuration of DRX cycle at a second half of a hyper frame (e.g., in a system frame with SFN 1023) but transmit the configuration of DRX cycle at a first half of a hyper frame (e.g., in a system frame with SFN 0 which follows the system frame with SFN 1023). This may lead misunderstanding between a network device and a terminal device about the value of Np.

Based on the above method as described in Embodiment 1, an indication of a half hyper frame is comprised in the configuration of DRX cycle. If the configuration of DRX cycle is generated at a second half of a hyper frame, the indication of the half hyper frame is indicated; otherwise, if the configuration of DRX cycle is generated at a first half of a hyper frame, the indication of the half hyper frame is not indicated. Then a terminal device may know that the configuration of DRX cycle is generated in a second half of a hyper frame. Thus, if the configuration of DRX cycle is received at a first half of a hyper frame, the terminal device may know, from the generation of the configuration of DRX cycle, that the current hyper frame is actually a second half of a hyper frame, therefore the value of Np should be one.

Then based on the equations (1) and (5), the terminal device 110 may determine a starting time for the DRX cycle.

In this way, mismatch between arrival time of packets and a starting time of a DRX cycle may be avoided and SFN wraparound mismatch may also be avoided.

### Embodiment 2

In this embodiment, an equation for determining a starting time of a DRX cycle is newly defined. Non-integer rational numbers in a DRX cycle is introduced and a round operation is applied so as to avoid mismatch between arrival time of packets and a starting time of a DRX cycle.

In some embodiments, the terminal device 110 may determine a value (also referred to as a first value herein) by performing a round operation for a product of an index of a DRX cycle and a periodicity of the DRX cycle, and determine a starting time of the DRX cycle at least based on the first value and the configuration of DRX cycle. In some embodiments, the periodicity of the DRX cycle may be a non-integer value. In some embodiments, the periodicity of the DRX cycle may be an integer value. In the context of the present application, the term “a periodicity of DRX cycle” and “a length of DRX cycle” may be used interchangeably.

In some embodiments, if the periodicity is a fractional number, the terminal device 110 may obtain a first product by multiplying the index of the DRX cycle with a numerator of the fractional number and obtain the first value by dividing the first product by a denominator of the fractional number.

In some embodiments, the configuration of DRX cycle may comprise an indication of a half hyper frame. In some embodiments, the indication of the half hyper frame may comprise a SFN (also referred to as a reference SFN herein). In some embodiments, the reference SEN may be 0. In some embodiments, the reference SEN may be 512. In some embodiments, the reference SFN may be any of {0, 1, . . . , 1023}. It is to be understood that the indication of the half hyper frame may also adopt any other suitable ways.

In some embodiments, the configuration of DRX cycle may also comprise a reference slot offset with respect to the reference SFN. In some embodiments, the terminal device 110 may determine a starting time of a DRX cycle at least based on the first value, the reference SFN and the reference slot offset.

For example, after a configuration of DRX cycle is configured or initialized or activated, the terminal device 110 may consider sequentially that the N″ DRX cycle occurs in the slot for which equation (6) below is true.

(N1×SFN+N2)=[(N1×SFN_{ref}+slot_{ref})+round(N×p)×N1/10]modulo(1024×N1) (6)

where N1 denotes the number of slots per frame, SFN denotes a system frame number, N2 denotes a slot number in a frame, p denotes the periodicity of DRX cycle, N denotes an index of the DRX cycle, SFN_{ref} denotes the reference SFN and slot_{ref} denotes the reference slot offset. In this example, round (N×p) may correspond to the first value described above.

In some embodiments, p may be equal to a periodicity of a long DRX cycle or a periodicity of a short cycle. In some embodiments, p may be an integer value. In some embodiments, p may be a non-integer value (i.e., fractional number), in the unit of millisecond, e.g., 1000/fps, where fps may be 30, 60, 90, 120 or any other suitable values.

For example, typical frame rates and their corresponding periodicities may be listed in Table 1 below.

TABLE 1

| Frame rate (fps) | 30 | 60 | 90 | 120 |
|---|---|---|---|---|
| periodicity (ms, in fractions) | 100/3 | 50/3 | 100/9 | 25/3 |

In some embodiments, if the configuration of DRX cycle is configured by a RRC signaling, SFN_{ref} may be provided by drx-timeReferenceSFN and slot_{ref} may be provided by drx-timeDomainOffset, where drx-timeReferenceSFN indicates a SFN used for determination of an offset of a resource in time domain, and drx-timeDomainOffset indicates an offset of a resource with respect to SFN=drx-timeReferenceSFN in time domain. In some embodiments, drx-timeReferenceSFN∈{0, 512}. In some alternative embodiments, drx-timeReferenceSFN∈{0, 1, . . . , 1023}. In some embodiments, the terminal device 110 may use the closest SFN with the indicated number preceding the reception of the configuration of DRX cycle.

In some embodiments, if the configuration of DRX cycle is dynamically indicated, e.g., if the configuration of DRX cycle is initialized or activated by a DCI, MAC CE or a wake-up signal (WUS), SFN_{ref} and slot_{ref} may be equal to SEN start time and slot start time, where SFN_{start time} and slot_{start time} are the SFN and slot, respectively, of the first DRX cycle where the DRX configuration was initialized or activated.

In some scenarios, as DRX cycle may switch between long DRX cycle and short DRX cycle, and N value for long DRX cycle cannot be used by short DRX cycle, and vice versa. In view of this, embodiments of the present disclosure provide management of N value for long and short DRX cycles. In some embodiments, the terminal device 110 may maintain a first count value (denoted as n1) for short DRX cycle and a second count value (denoted as n2) for long DRX cycle. In some embodiments, the terminal device 110 may maintain the first count value n1 for short DRX cycle, and determine the second count value n2 for long DRX cycle based on the first count value n1, a periodicity of the long DRX cycle, and a periodicity of the short DRX cycle. For example, the second count value n2 may be determined based on equation (7) below.

n2=floor[n1/(p1/p2)] (7)

where n2 denotes the count value for long DRX cycle, n1 denotes the count value for short DRX cycle, p1 denotes the periodicity for long DRX cycle, p2 denotes the periodicity for short DRX cycle.

In some embodiments, both n1 and n2 may be reset to 0 when the configuration of DRX cycle is configured or initialized or activated.

In some embodiments, the configuration of DRX cycle does not comprise a start offset for DRX cycle (e.g., drx-StartOffet) and a slot offset for DRX cycle (e.g., drx-SlotOffset).

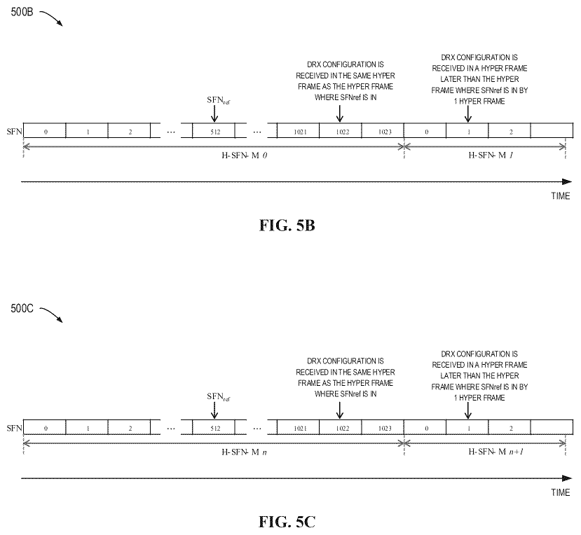

FIG. 5A illustrates a schematic diagram 500A illustrating an example configuration of DRX cycle according to embodiments of the present disclosure. In this example, a periodicity of traffic is 60 fps, and thus a periodicity of DRX cycle is 1000/60 ms=50/3 ms=16.67 ms. The traffic and DRX cycle are re-aligned in every 50 ms. In this example, SFN_{ref} and slot_{ref} indicate point of time A. According to the equation (6), it can be calculated that a starting time of the first DRX cycle (index=0) is 0 (point of time A), a starting time of the second DRX cycle (index=1) is 17 ms (point of time B), a starting time of the third DRX cycle (index=2) is 33 ms (point of time C), and a starting time of the fourth DRX cycle (index=3) is 50 ms (point of time D). It can be seen that arrival of the traffic and a starting time of DRX cycle are substantially aligned. It is to be understood that FIG. 5A is merely an example, and is not intended for limitation.

In this way, mismatch between arrival time of packets and a starting time of a DRX cycle may be avoided in unit of slot. In particular, a DRX cycle may be roughly aligned with a periodicity of packet arrival time, and thus additional power consumption due to the misalignment may be avoided. There is no accumulated offset between DRX cycle and the packet arrival time, and thus it is avoided that the packet arrives at the time outside the on duration of the DRX cycle. Compared with ceil or floor operation, round operation on periodicity is better aligned with the packet arrival time. Taking 90 fps as an example, the periodicity is 11.11 ms, for ceil operation, it is round up to 12 ms (the offset is 0.89 ms); for round operation, it is round down to 11 ms (the offset is 0.11 ms).

### Embodiment 3

This embodiment is a modification of Embodiment 2. In this embodiment, the configuration of DRX cycle may comprise the indication of the half hyper frame and a subframe number (also referred to as a reference subframe number herein). In some embodiments, the indication of the half hyper frame may comprise the reference SFN. Of course, any other suitable forms are also feasible. In some embodiments, the terminal device 110 may determine a subframe associated with the DRX cycle at least based on the reference SFN, the subframe number, an index of the DRX cycle and a periodicity of the DRX cycle. Then the terminal device 110 may determine the starting time of the DRX cycle based on the subframe and a slot offset (e.g., drx-SlotOffset) with respect to the subframe.

In some embodiments, if a short DRX cycle is used for a DRX group, and equation (8) below is true, the terminal device 110 may start an on-duration timer (e.g., drx-onDurationTimer) for this DRX group after a slot offset for DRX cycle (e.g., drx-SlotOffset) from the beginning of the subframe.

SFN×10+Nsub=[(10×SFN_{ref}+subframe_{ref})+round(n1×p2)]modulo 10240 (8)

where SFN denotes a system frame number, Nsub denotes a subframe number, n1 denotes the count value for short DRX cycle, and p2 denotes the periodicity for short DRX cycle.

In some embodiments, if a long DRX cycle is used for a DRX group, and equation (9) below is true, the terminal device 110 may start an on-duration timer (e.g., drx-onDuration Timer) for this DRX group after a slot offset for DRX cycle (e.g., drx-SlotOffset) from the beginning of the subframe.

SFN×10+Nsub=[(10×SFN_{ref}+subframe_{ref})+round(n2×p1)]modulo 10240 (9)

where SFN denotes a system frame number, Nsub denotes a subframe number, n2 denotes the count value for long DRX cycle, and p1 denotes the periodicity for long DRX cycle.

In some embodiments, if the configuration of DRX cycle is configured by a RRC signaling, SFN_{ref} may be provided by drx-timeReferenceSEN and slot_{ref} may be provided by drx-timeDomainOffset, where drx-timeReferenceSFN indicates a SFN used for determination of an offset of a resource in time domain in unit of Ims, and drx-timeDomainOffset indicates an offset of a resource with respect to SFN=drx-timeReferenceSFN in time domain. In some embodiments, drx-timeReferenceSFN∈{0, 512}. In some embodiments, the terminal device 110 may use the closest SFN with the indicated number preceding the reception of the configuration of DRX cycle.

In some embodiments, if the configuration of DRX cycle is dynamically indicated, e.g., if the configuration of DRX cycle is initialized or activated by a DCI, MAC CE or WUS, SFN_{ref} and subframe_{ref} may be equal to SFN_{start time} and subframe_{start time}, where SFN_{start time} and subframe_{start time} are the SFN and subframe, respectively, of the first DRX cycle where the DRX configuration was initialized or activated.

In this way, mismatch between arrival time of packets and a starting time of a DRX cycle may be avoided in unit of subframe.

### Embodiment 4

In this embodiment, a reference hyper frame is introduced to resolve the above mismatch issues comprising the mismatch between arrival time of packets and a starting time of a DRX cycle and the SFN wraparound mismatch.

In some embodiments, the terminal device 110 may determine a reference hyper frame based on a configuration of DRX cycle. In some embodiments, the configuration of DRX cycle may comprise an indication of a half hyper frame. If the configuration of DRX cycle is configured by a RRC signaling, the terminal device 110 may determine, as the reference hyper frame, a hyper frame associated with the half hyper frame. If the configuration of DRX cycle is dynamically indicated, the terminal device 110 may determine, as the reference hyper frame, a hyper frame associated with the first DRX cycle where the configuration of DRX cycle is indicated.

Then the terminal device 110 may determine information of a hyper frame (for convenience, denoted as H-SFN-M herein) based on the reference hyper frame and an index of the DRX cycle. In some embodiments, the reference hyper frame may correspond to an initial value of H-SEN-M, e.g., 0. It is to be understood that any other suitable values may also be adopted as the initial value. The H-SFN-M may indicates a hyper frame which increments by one when the SFN wraps around (e.g., from SFN 1023 to SFN 0). In some embodiments, H-SEN-M may be set to 0 when an index of a DRX cycle is 0.

In some embodiments, the terminal device 110 may determine a starting time for a DRX cycle at least based on the configuration of DRX cycle and H-SFN-M. In some embodiments, the configuration of DRX cycle may comprise a reference SFN and a reference slot offset with respect to the reference SFN. After a configuration of DRX cycle is configured or initialized or activated, the terminal device 110 may consider sequentially that the N^{th} DRX cycle occurs in the slot for which equation (10) below is true.

(H-SFN-M×1024×N1+N1×SFN+N2)=[(N1×SFN_{ref}+slot_{ref})+round(N×p)×N1/10] (10)

where H-SFN-M refers to information of a hyper frame associated with the N^{th} DRX cycle, N1 denotes the number of slots per frame, SEN denotes a system frame number, N2 denotes a slot number in a frame, p denotes the periodicity of DRX cycle, N denotes an index of the DRX cycle, SFN_{ref} denotes the reference SFN and slot_{ref} denotes the reference slot offset.

In some embodiments, the round operation in equation (10) may be replaced with a ceil operation. In some embodiments, the round operation in equation (10) may be replaced with a floor operation.

In some embodiments, if the configuration of DRX cycle is configured by a RRC signaling, SFN_{ref} may be provided by drx-timeReferenceSFN and slot_{ref} may be provided by drx-timeDomainOffset, where drx-timeReferenceSFN indicates a SEN used for determination of an offset of a resource in time domain and the terminal device 110 uses the closest SFN with the indicated number preceding the reception of the configuration of DRX cycle, and drx-timeDomainOffset indicates an offset of a resource with respect to SFN=drx-timeReferenceSEN in time domain. In some embodiments, drx-timeReferenceSFN∈{0, 512}. In some alternative embodiments, drx-timeReferenceSFN∈{0, 1, . . . , 1023}. Based on the SFN_{ref}: the terminal device 110 may determine which hyper frame the SFN_{ref} is in, and consider this hyper frame as corresponding to H-SFN-M=0. In other words, H-SEN-M is set to 0 when N is 0. For illustration, an example of how to determine H-SFN-M=0 will be described in connection with FIG. 5B.

FIG. 5B illustrates a schematic diagram 500B illustrating another example configuration of DRX cycle according to embodiments of the present disclosure. In this example, SFN_{ref} indicates SFN 512. As shown in FIG. 5B, if the configuration of DRX cycle is received in SFN 1022 which is in the same hyper frame as the hyper frame where SFN_{ref} is in, this hyper frame corresponds to H-SEN-M 0. If the configuration of DRX cycle is received in a hyper frame later than a hyper frame where SFN_{ref} is in by 1 hyper frame, the hyper frame where the configuration of DRX cycle is received is considered as corresponding to H-SFN-M=1. It is to be understood that FIG. 5B is merely an example, and is not intended for limitation.

In some embodiments, if the configuration of DRX cycle is dynamically indicated, e.g., if the configuration of DRX cycle is initialized or activated by a DCI, MAC CE or a wake-up signal (WUS), SFN_{ref} and slot_{ref} may be equal to SFN_{start time} and slot_{start time}, where SFN_{start time} and slot_{start time} are the SFN and slot, respectively, of the first DRX cycle where the DRX configuration was initialized or activated. H-SFN-M may be set 0 for the first DRX cycle where the DRX configuration was initialised or activated. In other words, H-SFN-M is set to 0 when N is 0.

In this way, a periodicity of DRX cycle may be roughly aligned with arrival time of a packet without accumulated latency, wasted resource and additional signaling overhead. Further, there is no need to reconfigure or reactivate DRX configuration when SFN wraps around, and thus signaling overhead may be reduced. In addition, embodiments of the present disclosure may support all currently known frame rates of applications as well as any potential frame rates in the future.

### Embodiment 5

In this embodiment, two H-SFN values are introduced as information of a hyper frame to resolve the above mismatch issues comprising the mismatch between arrival time of packets and a starting time of a DRX cycle and the SFN wraparound mismatch.

In some embodiments, the terminal device 110 may receive, from the network device 120, system information indicating a first H-SFN (for convenience, denoted as H-SFN-M₁ herein) of the hyper frame. In some embodiments, the terminal device 110 may obtain the H-SFN-M₁ from SIBI. For example, H-SFN-M₁ may be equal to hyperSFNM which is provided by a RRC signaling. The hyperSFNM may indicate a hyper frame which increments by one when the SFN wraps around (from SFN 1023 to SEN 0). In some embodiments, a H-SFN cycle may corresponds to a duration of 1000 H-SFNs, that is, the value range of H-SFN is 0~999 (e.g., a H-SFN cycle value of 100 or 10 may be used for XR traffic). Here, the H-SFN range 0~999 is taken as an example. It is to be understood that any other suitable value ranges are also feasible.

The terminal device 110 may determine a second H-SFN (for convenience, denoted as H-SFN-M₂ herein) based on the configuration of DRX cycle. In some embodiments, the configuration of DRX cycle may comprise an indication of a half hyper frame. In some embodiments, the indication of the half hyper frame may comprise the reference SFN. Of course, any other suitable forms are also feasible. If the configuration of DRX cycle is configured by a RRC signaling, the terminal device 110 may determine a third H-SFN associated with the half hyper frame, and determine the second H-SFN based on the third H-SFN.

In some embodiments, if the configuration of DRX cycle is dynamically indicated, the terminal device 110 may determine the second H-SFN based on a hyper frame associated with the first DRX cycle where the configuration of DRX cycle is indicated.

Then the terminal device 110 may determine the starting time at least based on the configuration of DRX cycle, the first H-SFN, the second H-SFN, and the number of H-SFNs in a H-SFN cycle. In some embodiments, the configuration of DRX cycle may comprise a reference SFN and a reference slot offset with respect to the reference SFN. After a configuration of DRX cycle is configured or initialized or activated, the terminal device 110 may consider sequentially that the N^{th} DRX cycle occurs in the slot for which equation (11) below is true.

(H-SFN-M₁×1024×N1+N1×SFN+N2)=[(H-SFN-M₂×1024×N1+N1×SFN_{ref}+slot_{ref})+round(N×p)×N1/10]modulo(N3×1024×N1) (11)

where H-SFN-M₁ refers to a H-SFN provided in system information (i.e., the first H-SFN), H-SFN-M₂ refers to a H-SFN determined from a configuration of DRX cycle (i.e., the second H-SFN), N1 denotes the number of slots per frame, SFN denotes a system frame number, N2 denotes a slot number in a frame, N3 denotes the number of H-SFNs in a H-SFN cycle, p denotes the periodicity of DRX cycle, N denotes an index of the DRX cycle, SFN_{ref} denotes the reference SFN and slot_{ref} denotes the reference slot offset. In this example, N3=1000. It is to be understood that N3 may take any suitable values.

In some embodiments, the round operation in the equation (11) may be replaced with a ceil operation. In some embodiments, the round operation in the equation (11) may be replaced with a floor operation.

In some embodiments, if the configuration of DRX cycle is configured by a RRC signaling, SFN_{ref} may be provided by drx-timeReferenceSFN and slot_{ref} may be provided by drx-timeDomainOffset, where drx-timeReferenceSFN indicates a SFN used for determination of an offset of a resource in time domain and the terminal device 110 uses the closest SFN with the indicated number preceding the reception of the configuration of DRX cycle, and drx-timeDomainOffset indicates an offset of a resource with respect to SFN=drx-timeReferenceSFN in time domain. In some embodiments, drx-timeReferenceSFN∈{0, 512}. In some alternative embodiments, drx-timeReferenceSFN∈{0, 1, . . . , 1023}. Based on the SFN_{ref}: the terminal device 110 may determine which hyper frame the SFN_{ref} is in. It is assumed that a configuration of DRX cycle is received in H-SFN-M_{DRX-Config} and SEN_{DRX-Config}. In some embodiments, if SFN_{ref} and SEN_{DRX-Config} are in the same H-SFN, H-SFN-M₂ is equal to H-SEN-M_{DRX-Config}. In some embodiments, if the hyper frame where SFN_{ref} is located is before the hyper frame where SFN_{DRX-Config} is located, H-SFN-M₂ is equal to H-SFN-M_{DRX-Config}−1.

For illustration, an example of how to determine H-SFN-M₂ will be described in connection with FIG. 5C. FIG. 5C illustrates a schematic diagram 500C illustrating another example configuration of DRX cycle according to embodiments of the present disclosure. In this example, SFN_{ref} indicates SFN 512. As shown in FIG. 5C, if the configuration of DRX cycle is received in SFN 1022 which is in the same hyper frame as the hyper frame where SFN_{ref} is in, and SFN 1022 belongs to H-SEN-M n, H-SFN-M₂ is equal to n. If the configuration of DRX cycle is received at SFN 1 in a hyper frame later than a hyper frame where SFN_{ref} is in by 1 hyper frame, and the SFN 1 belongs to H-SFN-M n+1, H-SFN-M₂ is equal to n+1−1=n. It is to be understood that FIG. 5C is merely an example, and is not intended for limitation.

In some embodiments, if the configuration of DRX cycle is dynamically indicated, e.g., if the configuration of DRX cycle is initialized or activated by a DCI, MAC CE or a wake-up signal (WUS), H-SFN-M₂ may be equal to H-SFN-M_{start time}, where H-SFN-M_{start time} are the H-SFN-M, respectively, of the first DRX cycle where the DRX configuration was initialized or activated.

In this way, a periodicity of DRX cycle may also be roughly aligned with arrival time of a packet without accumulated latency, wasted resource and additional signaling overhead. Further, there is no need to reconfigure or reactivate DRX configuration when SFN wraps around, and thus signaling overhead may be reduced. In addition, embodiments of the present disclosure may support all currently known frame rates of applications as well as any potential frame rates in the future.

It is to be understood that any of the above equations is merely for example and is not for limitation. Any other suitable forms may also be feasible.

So far, determination of a starting time of a DRX cycle is described in connection with Embodiments 1 to 5. It is to be understood that Embodiments 1 to 5 may be used separately or in any suitable combination.

Return to FIG. 3, upon determination of the starting time, the terminal device 110 performs 303 a downlink channel monitoring based on the starting time. For example, the terminal device 110 will start PDCCH monitoring at the starting time.

Similarly, upon transmission of the DRX configuration, the network device 120 also determines 304 the starting time for the DRX cycle. The operations for the determination 304 are similar with the operations for the determination 302, and thus are not repeated here for concise. Upon determination of the starting time, the network device 120 performs 305 a downlink channel transmission.

With the process of FIG. 3, a DRX cycle may be roughly aligned with the periodicity of a packet arrival time, and thus additional power consumption due to the misalignment may be avoided. No accumulated offset between DRX cycle and the packet arrival time, and thus it is avoided that the packet arrives at the time outside the on duration of the DRX cycle. Meanwhile, the above SFN wraparound mismatch issue is overcome.

### Example Implementation of Methods

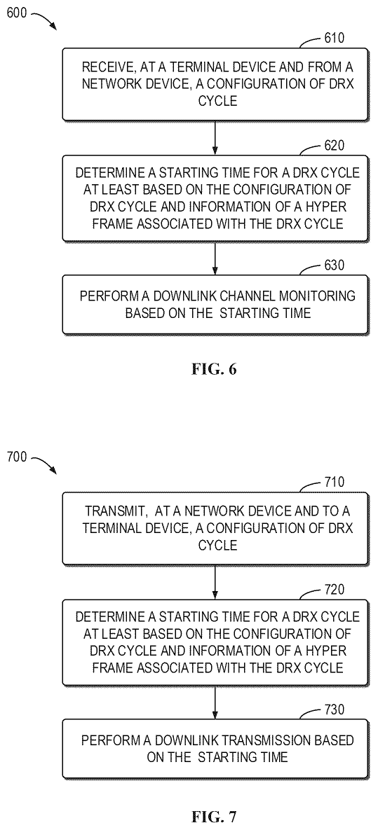

Accordingly, embodiments of the present disclosure provide methods of communication implemented at a terminal device and a network device. These methods will be described below with reference to FIGS. 6 to 7.

FIG. 6 illustrates an example method 600 of communication implemented at a terminal device in accordance with some embodiments of the present disclosure. For example, the method 600 may be performed at the terminal device 110 as shown in FIG. 1. For the purpose of discussion, in the following, the method 600 will be described with reference to FIG. 1. It is to be understood that the method 600 may include additional blocks not shown and/or may omit some blocks as shown, and the scope of the present disclosure is not limited in this regard.

At block 610, the terminal device 110 receives, from the network device 120, a configuration of DRX cycle. In some embodiments, the configuration may comprise an indication of a half hyper frame. In some embodiments, the indication of a half hyper frame may comprise a SFN (i.e., a reference SFN). In some embodiments, the configuration may also comprise a subframe number. In some embodiments, the configuration may also comprise a reference slot offset with respect to the reference SFN. In some embodiments, the configuration may also comprise at least one of the following: a length of DRX cycle, a start offset for DRX cycle or a slot offset for DRX cycle. In some embodiments, the length of DRX cycle may be a non-integer value. In some embodiments, the length of DRX cycle may be an integer value.

At block 620, the terminal device 110 determines a starting time for a DRX cycle at least based on the configuration of DRX cycle and information of a hyper frame associated with the DRX cycle. In some embodiments, the terminal device 110 may determine the starting time based on the equations (1) and (5). In some embodiments, the terminal device 110 may determine the starting time based on any of the equations (6) and (8) to (11).

In some embodiments, the terminal device 110 may determine a reference hyper frame based on the configuration of DRX cycle, and determine the information of the hyper frame based on the reference hyper frame and an index of the DRX cycle.

In some embodiments where the configuration of DRX cycle comprises an indication of a half hyper frame, if the configuration of DRX cycle is configured by a radio resource control signaling, the terminal device 110 may determine, as the reference hyper frame, a hyper frame associated with the half hyper frame. If the configuration of DRX cycle is dynamically indicated, the terminal device 110 may determine, as the reference hyper frame, a hyper frame associated with the first DRX cycle where the configuration of DRX cycle is indicated.

In some embodiments, the terminal device 110 may receive, from the network device 120, system information indicating a first H-SFN of the hyper frame. The terminal device 110 may determine a second H-SFN based on the configuration of DRX cycle. The terminal device 110 may determine the starting time at least based on the configuration of DRX cycle, the first H-SFN, the second H-SFN, and the number of H-SFNs in a H-SFN cycle.

In some embodiments where the configuration of DRX cycle comprises an indication of a half hyper frame, if the configuration of DRX cycle is configured by a radio resource control signaling, the terminal device 110 may determine a third H-SFN associated with the half hyper frame, and determine the second H-SFN based on the third H-SFN. If the configuration of DRX cycle is dynamically indicated, the terminal device 110 may determine the second H-SFN based on a hyper frame associated with the first DRX cycle where the configuration of DRX cycle is indicated.

In some embodiments, the terminal device 110 may determine a first value by performing a round operation for a product of an index of the DRX cycle and a periodicity of the DRX cycle, and determine the starting time based on the configuration of DRX cycle, the information of the hyper frame and the first value.

In some embodiments, if the periodicity is a fractional number, the terminal device 110 may obtain a first product by multiplying the index of the DRX cycle with a numerator of the fractional number, and obtain the first value by dividing the first product by a denominator of the fractional number.

In some embodiments where the configuration of DRX cycle comprises a SFN, a subframe number and a slot offset for DRX cycle, the terminal device 110 may determine a subframe associated with a DRX cycle at least based on the SFN, the subframe number, an index of the DRX cycle and a periodicity of the DRX cycle, and determine the starting time based on the subframe and the slot offset.

In some embodiments, the terminal device 110 may maintain a first count value for a short DRX cycle and a second count value for a long DRX cycle.

In some embodiments, the terminal device 110 may maintain a first count value for a short DRX cycle, and determine a second count value for a long DRX cycle based on the first count value, a periodicity of the long DRX cycle, and a periodicity of the short DRX cycle.

At block 630, the terminal device 110 performs a downlink channel monitoring based on the determined starting time.

With the method of FIG. 6, a starting time of a DRX cycle may be roughly aligned with a packet arrive time without the SFN wraparound mismatch issue.

FIG. 7 illustrates another example method 700 of communication implemented at a network device in accordance with some embodiments of the present disclosure. For example, the method 700 may be performed at the network device 120 as shown in FIG. 1. For the purpose of discussion, in the following, the method 700 will be described with reference to FIG. 1. It is to be understood that the method 700 may include additional blocks not shown and/or may omit some blocks as shown, and the scope of the present disclosure is not limited in this regard.

As shown in FIG. 7, at block 710, the network device 120 transmits, to the terminal device 110, a configuration of DRX cycle. In some embodiments, the configuration may comprise an indication of a half hyper frame. In some embodiments, the indication of a half hyper frame may comprise a SFN (i.e., a reference SFN). In some embodiments, the configuration may also comprise a subframe number. In some embodiments, the configuration may also comprise a reference slot offset with respect to the reference SFN. In some embodiments, the configuration may also comprise at least one of the following: a length of DRX cycle, a start offset for DRX cycle or a slot offset for DRX cycle. In some embodiments, the length of DRX cycle may be a non-integer value. In some embodiments, the length of DRX cycle may be an integer value.

At block 720, the network device 120 determines a starting time for a DRX cycle at least based on the configuration of DRX cycle and information of a hyper frame associated with the DRX cycle. In some embodiments, the network device 120 may determine the starting time based on the equations (1) and (5). In some embodiments, the network device 120 may determine the starting time based on any of the equations (6) and (8) to (11).

In some embodiments, the network device 120 may determine a reference hyper frame based on the configuration of DRX cycle, and determine the information of the hyper frame based on the reference hyper frame and an index of the DRX cycle.

In some embodiments where the configuration of DRX cycle comprises an indication of a half hyper frame, if the configuration of DRX cycle is configured by a radio resource control signaling, the network device 120 may determine, as the reference hyper frame, a hyper frame associated with the half hyper frame. If the configuration of DRX cycle is dynamically indicated, the network device 120 may determine, as the reference hyper frame, a hyper frame associated with the first DRX cycle where the configuration of DRX cycle is indicated.

In some embodiments, the network device 120 may transmit, to the terminal device 110, system information indicating a first H-SFN of the hyper frame. The network device 120 may determine a second H-SFN based on the configuration of DRX cycle. The network device 120 may determine the starting time at least based on the configuration of DRX cycle, the first H-SFN, the second H-SFN, and the number of H-SFNs in a H-SFN cycle.

In some embodiments where the configuration of DRX cycle comprises an indication of a half hyper frame, if the configuration of DRX cycle is configured by a radio resource control signaling, the network device 120 may determine a third H-SFN associated with the half hyper frame, and determine the second H-SFN based on the third H-SFN. If the configuration of DRX cycle is dynamically indicated, the network device 120 may determine the second H-SFN based on a hyper frame associated with the first DRX cycle where the configuration of DRX cycle is indicated.

In some embodiments, the network device 120 may determine a first value by performing a round operation for a product of an index of the DRX cycle and a periodicity of the DRX cycle, and determine the starting time based on the configuration of DRX cycle, the information of the hyper frame and the first value.

In some embodiments, if the periodicity is a fractional number, the network device 120 may obtain a first product by multiplying the index of the DRX cycle with a numerator of the fractional number, and obtain the first value by dividing the first product by a denominator of the fractional number.

In some embodiments where the configuration of DRX cycle comprises a SFN, a subframe number and a slot offset for DRX cycle, the network device 120 may determine a subframe associated with a DRX cycle at least based on the SFN, the subframe number, an index of the DRX cycle and a periodicity of the DRX cycle, and determine the starting time based on the subframe and the slot offset.

In some embodiments, the network device 120 may maintain a first count value for a short DRX cycle and a second count value for a long DRX cycle.

In some embodiments, the network device 120 may maintain a first count value for a short DRX cycle, and determine a second count value for a long DRX cycle based on the first count value, a periodicity of the long DRX cycle, and a periodicity of the short DRX cycle.

At block 730, the network device 120 performs a downlink transmission based on the determined starting time.

With the method of FIG. 7, a starting time of a DRX cycle may be roughly aligned with a packet arrive time without the SFN wraparound mismatch issue.

### Example Implementation of Devices

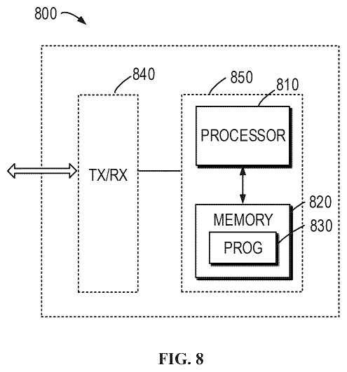

FIG. 8 is a simplified block diagram of a device 800 that is suitable for implementing embodiments of the present disclosure. The device 800 can be considered as a further example implementation of the terminal device 110 or the network device 120 as shown in FIG. 1. Accordingly, the device 800 can be implemented at or as at least a part of the terminal device 110 or the network device 120.

As shown, the device 800 includes a processor 810, a memory 820 coupled to the processor 810, a suitable transmitter (TX) and receiver (RX) 840 coupled to the processor 810, and a communication interface coupled to the TX/RX 840. The memory 810 stores at least a part of a program 830. The TX/RX 840 is for bidirectional communications. The TX/RX 840 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 830 is assumed to include program instructions that, when executed by the associated processor 810, enable the device 800 to operate in accordance with the embodiments of the present disclosure, as discussed herein with reference to FIGS. 3 to 7. The embodiments herein may be implemented by computer software executable by the processor 810 of the device 800, or by hardware, or by a combination of software and hardware. The processor 810 may be configured to implement various embodiments of the present disclosure. Furthermore, a combination of the processor 810 and memory 820 may form processing means 850 adapted to implement various embodiments of the present disclosure.

The memory 820 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

In some embodiments, a terminal device comprises circuitry configured to: receive, from a network device, a configuration of DRX cycle; determine a starting time for a DRX cycle at least based on the configuration of DRX cycle and information of a hyper frame associated with the DRX cycle; and perform a downlink channel monitoring based on the starting time.

In some embodiments, a network device comprise a circuitry configured to: transmit, to a terminal device, a configuration of DRX cycle; determine a starting time for a DRX cycle at least based on the configuration of DRX cycle and information of a hyper frame associated with the DRX cycle; and perform a downlink transmission based on the starting time.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure may provide the following solutions.

In one solution, a method of communication comprises: receiving, at a terminal device and from a network device, a configuration of discontinuous reception (DRX) cycle; determining a starting time for a DRX cycle at least based on the configuration of DRX cycle and information of a hyper frame associated with the DRX cycle; and performing a downlink channel monitoring based on the starting time.

In some embodiments, the method above further comprises: determining a reference hyper frame based on the configuration of DRX cycle; and determining the information of the hyper frame based on the reference hyper frame and an index of the DRX cycle.

In some embodiments, the configuration of DRX cycle comprises an indication of a half hyper frame. In these embodiments, determining the reference hyper frame comprises: in accordance with a determination that the configuration of DRX cycle is configured by a radio resource control signaling, determining, as the reference hyper frame, a hyper frame associated with the half hyper frame; and in accordance with a determination that the configuration of DRX cycle is dynamically indicated, determining, as the reference hyper frame, a hyper frame associated with the first DRX cycle where the configuration of DRX cycle is indicated.

In some embodiments, determining the starting time comprises: receiving, from the network device, system information indicating a first hyper system frame number (H-SFN) of the hyper frame; determining a second H-SFN based on the configuration of DRX cycle; and determining the starting time at least based on the configuration of DRX cycle, the first H-SFN, the second H-SFN, and the number of H-SFNs in a H-SFN cycle.

In some embodiments, the configuration of DRX cycle comprises an indication of a half hyper frame. In these embodiments, determining the second H-SFN comprises: in accordance with a determination that the configuration of DRX cycle is configured by a radio resource control signaling, determining a third H-SFN associated with the half hyper frame; and determining the second H-SFN based on the third H-SFN; and in accordance with a determination that the configuration of DRX cycle is dynamically indicated, determining the second H-SFN based on a hyper frame associated with the first DRX cycle where the configuration of DRX cycle is indicated.

In some embodiments, determining the starting time comprises: determining a first value by performing a round operation for a product of an index of the DRX cycle and a periodicity of the DRX cycle; and determining the starting time based on the configuration of DRX cycle, the information of the hyper frame and the first value.

In some embodiments, performing the round operation comprises: in accordance with a determination that the periodicity is a fractional number, obtaining a first product by multiplying the index of the DRX cycle with a numerator of the fractional number; and obtaining the first value by dividing the first product by a denominator of the fractional number.

In some embodiments, the indication of the half hyper frame comprises a system frame number (SFN).

In some embodiments, the configuration of DRX cycle further comprises a subframe number.

In some embodiments, determining the starting time comprises: determining a subframe associated with the DRX cycle at least based on the SFN, the subframe number, an index of the DRX cycle and a periodicity of the DRX cycle; and determining the starting time based on the subframe and a slot offset with respect to the subframe.

In some embodiments, the method further comprises: maintaining a first count value for a short DRX cycle and a second count value for a long DRX cycle.

In some embodiments, the method further comprises: maintaining a first count value for a short DRX cycle; and determining a second count value for a long DRX cycle based on the first count value, a periodicity of the long DRX cycle, and a periodicity of the short DRX cycle.

In another solution, a method of communication comprises: transmitting, at a network device and from a terminal device, a configuration of discontinuous reception (DRX) cycle; determining a starting time for a DRX cycle at least based on the configuration of DRX cycle and information of a hyper frame associated with the DRX cycle; and performing a downlink transmission based on the starting time.

In some embodiments, the method above further comprises: determining a reference hyper frame based on the configuration of DRX cycle; and determining the information of the hyper frame based on the reference hyper frame and an index of the DRX cycle.

In some embodiments, the configuration of DRX cycle comprises an indication of a half hyper frame. In these embodiments, determining the reference hyper frame comprises: in accordance with a determination that the configuration of DRX cycle is configured by a radio resource control signaling, determining, as the reference hyper frame, a hyper frame associated with the half hyper frame; and in accordance with a determination that the configuration of DRX cycle is dynamically indicated, determining, as the reference hyper frame, a hyper frame associated with the first DRX cycle where the configuration of DRX cycle is indicated.

In some embodiments, the method further comprises: transmitting, from the network device, system information indicating a first hyper system frame number (H-SFN) of the hyper frame. In these embodiments, determining the starting time comprises: determining a second H-SFN based on the configuration of DRX cycle; and determining the starting time at least based on the configuration of DRX cycle, the first H-SFN, the second H-SFN, and the number of H-SFNs in a H-SFN cycle.

In some embodiments, the configuration of DRX cycle comprises an indication of a half hyper frame. In these embodiments, determining the second H-SFN comprises: in accordance with a determination that the configuration of DRX cycle is configured by a radio resource control signaling, determining a third H-SFN associated with the half hyper frame; and determining the second H-SFN based on the third H-SFN; and in accordance with a determination that the configuration of DRX cycle is dynamically indicated, determining the second H-SFN based on a hyper frame associated with the first DRX cycle where the configuration of DRX cycle is indicated.

In some embodiments, determining the starting time comprises: determining a first value by performing a round operation for a product of an index of the DRX cycle and a periodicity of the DRX cycle; and determining the starting time based on the configuration of DRX cycle, the information of the hyper frame and the first value.

In some embodiments, performing the round operation comprises: in accordance with a determination that the periodicity is a fractional number, obtaining a first product by multiplying the index of the DRX cycle with a numerator of the fractional number; and obtaining the first value by dividing the first product by a denominator of the fractional number.

In some embodiments, the indication of the half hyper frame comprises a system frame number (SFN).

In some embodiments, the configuration of DRX cycle further comprises a subframe number.

In some embodiments, determining the starting time comprises: determining a subframe associated with the DRX cycle at least based on the SFN, the subframe number, an index of the DRX cycle and a periodicity of the DRX cycle; and determining the starting time based on the subframe and a slot offset with respect to the subframe.

In some embodiments, the method further comprises: maintaining a first count value for a short DRX cycle and a second count value for a long DRX cycle.

In some embodiments, the method further comprises: maintaining a first count value for a short DRX cycle; and determining a second count value for a long DRX cycle based on the first count value, a periodicity of the long DRX cycle, and a periodicity of the short DRX cycle.

In another solution, a device of communication comprises: a processor configured to cause the device to perform any of the methods above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 3 to 7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method of communication, comprising:
receiving, at a terminal device and from a network device, a configuration of discontinuous reception (DRX) cycle;
determining a starting time for a DRX cycle at least based on the configuration of DRX cycle and information of a hyper frame associated with the DRX cycle; and
performing a downlink channel monitoring based on the starting time.

2. The method of claim 1, further comprising:
determining a reference hyper frame based on the configuration of DRX cycle; and
determining the information of the hyper frame based on the reference hyper frame and an index of the DRX cycle.

3. The method of claim 2, wherein the configuration of DRX cycle comprises an indication of a half hyper frame, and wherein determining the reference hyper frame comprises:
in accordance with a determination that the configuration of DRX cycle is configured by a radio resource control signaling, determining, as the reference hyper frame, a hyper frame associated with the half hyper frame; and
in accordance with a determination that the configuration of DRX cycle is dynamically indicated, determining, as the reference hyper frame, a hyper frame associated with the first DRX cycle where the configuration of DRX cycle is indicated.

4. The method of claim 1, wherein determining the starting time comprises:
receiving, from the network device, system information indicating a first hyper system frame number (H-SFN) of the hyper frame;
determining a second H-SFN based on the configuration of DRX cycle; and
determining the starting time at least based on the configuration of DRX cycle, the first H-SFN, the second H-SFN, and the number of H-SFNs in a H-SFN cycle.

5. The method of claim 4, wherein the configuration of DRX cycle comprises an indication of a half hyper frame, and wherein determining the second H-SFN comprises:
in accordance with a determination that the configuration of DRX cycle is configured by a radio resource control signaling,
determining a third H-SFN associated with the half hyper frame; and
determining the second H-SFN based on the third H-SFN; and
in accordance with a determination that the configuration of DRX cycle is dynamically indicated, determining the second H-SFN based on a hyper frame associated with the first DRX cycle where the configuration of DRX cycle is indicated.

6. The method of claim 1, wherein determining the starting time comprises:
determining a first value by performing a round operation for a product of an index of the DRX cycle and a periodicity of the DRX cycle; and
determining the starting time based on the configuration of DRX cycle, the information of the hyper frame and the first value.

7. The method of claim 6, wherein performing the round operation comprises:
in accordance with a determination that the periodicity is a fractional number, obtaining a first product by multiplying the index of the DRX cycle with a numerator of the fractional number; and
obtaining the first value by dividing the first product by a denominator of the fractional number.

8. The method of claim 3, wherein the indication of the half hyper frame comprises a system frame number (SFN).

9. The method of claim 8, wherein the configuration of DRX cycle further comprises a subframe number.

10. The method of claim 9, wherein determining the starting time comprises:
determining a subframe associated with the DRX cycle at least based on the SFN, the subframe number, an index of the DRX cycle and a periodicity of the DRX cycle; and
determining the starting time based on the subframe and a slot offset with respect to the subframe.

11. The method of claim 1, further comprising:
maintaining a first count value for a short DRX cycle and a second count value for a long DRX cycle.

12. The method of claim 1, further comprising:
maintaining a first count value for a short DRX cycle; and
determining a second count value for a long DRX cycle based on the first count value, a periodicity of the long DRX cycle, and a periodicity of the short DRX cycle.

13. A method of communication, comprising:
transmitting, at a network device and from a terminal device, a configuration of discontinuous reception (DRX) cycle;
determining a starting time for a DRX cycle at least based on the configuration of DRX cycle and information of a hyper frame associated with the DRX cycle; and
performing a downlink transmission based on the starting time.

14. The method of claim 13, further comprising:
determining a reference hyper frame based on the configuration of DRX cycle; and
determining the information of the hyper frame based on the reference hyper frame and an index of the DRX cycle.

15. The method of claim 14, wherein the configuration of DRX cycle comprises an indication of a half hyper frame, and wherein determining the reference hyper frame comprises:
in accordance with a determination that the configuration of DRX cycle is configured by a radio resource control signaling, determining, as the reference hyper frame, a hyper frame associated with the half hyper frame; and
in accordance with a determination that the configuration of DRX cycle is dynamically indicated, determining, as the reference hyper frame, a hyper frame associated with the first DRX cycle where the configuration of DRX cycle is indicated.

16. The method of claim 13, further comprising:
transmitting, from the network device, system information indicating a first hyper system frame number (H-SFN) of the hyper frame;
wherein determining the starting time comprises:
determining a second H-SFN based on the configuration of DRX cycle; and
determining the starting time at least based on the configuration of DRX cycle, the first H-SFN, the second H-SFN, and the number of H-SFNs in a H-SFN cycle.

17. The method of claim 16, wherein the configuration of DRX cycle comprises an indication of a half hyper frame, and wherein determining the second H-SFN comprises:
in accordance with a determination that the configuration of DRX cycle is configured by a radio resource control signaling,
determining a third H-SFN associated with the half hyper frame; and
determining the second H-SFN based on the third H-SFN; and
in accordance with a determination that the configuration of DRX cycle is dynamically indicated, determining the second H-SFN based on a hyper frame associated with the first DRX cycle where the configuration of DRX cycle is indicated.

18. The method of claim 13, wherein determining the starting time comprises:
determining a first value by performing a round operation for a product of an index of the DRX cycle and a periodicity of the DRX cycle; and
determining the starting time based on the configuration of DRX cycle, the information of the hyper frame and the first value.

19. The method of claim 18, wherein performing the round operation comprises:
in accordance with a determination that the periodicity is a fractional number, obtaining a first product by multiplying the index of the DRX cycle with a numerator of the fractional number; and
obtaining the first value by dividing the first product by a denominator of the fractional number.

20. (canceled)
